(19) United States
(12) Patent Application Publication
(10) Pub. No.: US 2024/0170861 A1
(43) Pub. Date: May 23, 2024

(54) TERMINAL-EQUIPPED ELECTRIC WIRE AND METHOD OF MANUFACTURING TERMINAL-EQUIPPED ELECTRIC WIRE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuji KAWATA, Osaka (JP); Kenji MIYAMOTO, Osaka (JP)

(21) Appl. No.: 18/282,770

(22) PCT Filed: Mar. 4, 2022
(86) PCT No.: PCT/JP2022/009273

§ 371 Date: Sep. 18, 2023

(30) Foreign Application Priority Data
Mar. 25, 2021 (JP) 2021-051158

(51) Int. Cl. H01R 4/18; H01R 4/62; H01R 43/048

(52) U.S. Cl. CPC H01R 4/183; H01R 4/62; H01R 43/048

(57) ABSTRACT

A terminal-equipped electric wire includes an electric wire in which a conductor composed of a plurality of bare strands is covered with an insulating coating, a tubular intermediate component, and a terminal; the terminal includes, at one end, a connecting portion for connection with a mating terminal and, at another end, a tubular coupling portion for coupling to the intermediate portion; the intermediate component includes, at one end, a first electromagnetically welding portion that is fitted onto and electromagnetically welded to the conductor exposed at a terminal end of the electric wire and, at another end, a second electromagnetically welding portion 38 that is fitted onto and electromagnetically welded to the coupling portion of the terminal; and the conductor of the electric wire and the intermediate component are made of the same type of metal.

### TECHNICAL FIELD

The present disclosure relates to a terminal-equipped electric wire and a method of manufacturing a terminal-equipped electric wire.

### BACKGROUND

Patent Document 1 discloses a terminal-equipped electric wire in which a conductor exposed at a terminal end of a coated electric wire is electromagnetically welded to a pressure welding portion of a terminal formed by a flat metal plate. In the terminal-equipped electric wire disclosed in Patent Document 1, the pressure welding portion of the terminal has a tubular shape having an approximate cross-sectional 6 shape in which one of a pair of protruding ends of a core wire barrel portion that protrude from two sides of a plate-shaped wire-mounting portion of the terminal is overlaid on the other protruding end. With the conductor of the coated electric wire inserted into the pressure welding portion constructed as above, the pressure welding portion is electromagnetically welded to the conductor. Hence, uniform pressure welding in the circumferential direction between the pressure welding portion and the conductor, which has been difficult to achieve through mechanical crimping, is possible, and the conductivity between the coated electric wire and the terminal can be increased.

### PRIOR ART DOCUMENT

### Patent Document

Patent Document 1: JP 2019-186082 A

### SUMMARY OF THE INVENTION

### Problems to be Solved

In the terminal-equipped electric wire of Patent Document 1, it is necessary to fabricate, from a flat metal plate, a terminal that integrally includes a cylindrical pressure welding portion, which may limit the degree of design freedom of the entire terminal including its connecting portion for connection with a mating terminal. In addition, since the conductor of the electric wire is composed of a plurality of bare strands, the rigidity of the conductor is lower than that of the pressure welding portion constituted by a rigid body. Therefore, if the conductor of the electric wire and the pressure welding portion of the terminal are made of different types of metal, it may not be possible to sufficiently ensure a pressure welding force of the electromagnetically welding part on the conductor due to a difference in linear expansion coefficients.

Disclosed are a terminal-equipped electric wire that can increase the degree of design freedom of the terminal and the pressure welding force of the electromagnetically welding part on the conductor and a method of manufacturing a terminal-equipped electric wire.

### Means to Solve the Problem

A terminal-equipped electric wire of the present disclosure includes: an electric wire in which a conductor composed of a plurality of bare strands is covered with an insulating coating, a tubular intermediate component, and a terminal, wherein the terminal includes, at one end, a connecting portion for connection with a mating terminal and, at another end, a tubular coupling portion for coupling to the intermediate portion; the intermediate component includes, at one end, a first electromagnetically welding portion that is fitted onto and electromagnetically welded to the conductor exposed at a terminal end of the electric wire and, at another end, a second electromagnetically welding portion that is fitted onto and electromagnetically welded to the coupling portion of the terminal, and the conductor of the electric wire and the intermediate component are made of the same type of metal.

A method of manufacturing a terminal-equipped electric wire of the present disclosure is a method of manufacturing a terminal-equipped electric wire that includes an electric wire in which a conductor composed of a plurality of bare strands is covered with an insulating coating, a tubular intermediate component, and a terminal, the method including the steps of: stripping off the insulating coating to expose the conductor at a terminal end of the electric wire; preparing the terminal, the terminal including, at one end, a connecting portion for connection with a mating terminal and, at another end, a tubular coupling portion for coupling to the intermediate portion; preparing the intermediate component, the intermediate component being made of the same type of metal as the conductor of the electric wire; and electromagnetic welding by fitting one end of the intermediate component onto the conductor exposed at a terminal end of the electric wire for electromagnetic welding to provide a first electromagnetically welding portion on the one end of the intermediate component, and fitting another end of the intermediate component onto the coupling portion of the terminal for electromagnetic welding to provide a second electromagnetically welding portion on the other end of the intermediate component.

### Effect of the Invention

According to the terminal-equipped electric wire and the method of manufacturing a terminal-equipped electric wire of the present disclosure, the degree of design freedom of the terminal and the pressure welding force of the electromagnetically welding part on the conductor can be increased.

### BRIEF DESCRIPTION OF THE DRAWINGS

FIG. 1 is an overall perspective view showing a terminal-equipped electric wire of Embodiment 1.

FIG. 2 is a plan view showing the terminal-equipped electric wire shown in FIG. 1.

FIG. 3 is a cross-sectional view taken along line of FIG. 2.

FIG. 4 is an exploded perspective view of the terminal-equipped electric wire shown in FIG. 1 prior to electromagnetic welding.

FIG. 5 is a right side view of the terminal-equipped electric wire shown in FIG. 1 prior to electromagnetic welding.

FIG. 6 is a front view of FIG. 5.

FIG. 7 is a cross-sectional view taken along line VII-VII of FIG. 6.

FIG. 8 is a cross-sectional view of the terminal-equipped electric wire shown in FIG. 1 after electromagnetic welding and corresponds to FIG. 7.

FIG. 9 is an overall perspective view showing the terminal-equipped electric wire of an Embodiment 2.

FIG. 10 is an exploded perspective view of the terminal-equipped electric wire shown in FIG. 9 prior to electromagnetic welding.

FIG. 11 is a cross-sectional view of the terminal-equipped electric wire shown in FIG. 9 prior to electromagnetic welding and corresponds to FIG. 7.

FIG. 12 is a cross-sectional view of the terminal-equipped electric wire shown in FIG. 9 after electromagnetic welding and corresponds to FIG. 8.

### DETAILED DESCRIPTION TO EXECUTE THE INVENTION

### Description of Embodiments of Disclosure

A terminal-equipped electric wire of the present disclosure is:
(1) A terminal-equipped electric wire including: an electric wire in which a conductor composed of a plurality of bare strands is covered with an insulating coating, a tubular intermediate component, and a terminal, wherein the terminal includes, at one end, a connecting portion for connection with a mating terminal and, at another end, a tubular coupling portion for coupling to the intermediate portion; the intermediate component includes, at one end, a first electromagnetically welding portion that is fitted onto and electromagnetically welded to the conductor exposed at a terminal end of the electric wire and, at another end, a second electromagnetically welding portion that is fitted onto and electromagnetically welded to the coupling portion of the terminal, and the conductor of the electric wire and the intermediate component are made of the same type of metal.

According to this structure, the three separate components, i.e., the electric wire, the intermediate component, and the terminal, are interconnected through electromagnetic welding to provide the terminal-equipped electric wire. Therefore, the component that is electromagnetically welded to the conductor exposed at a terminal end of the electric wire, i.e., the intermediate component, can be separated from the terminal. As a result, compared with a conventional structure that requires fabricating, from a flat metal plate, a terminal with an integrated tubular pressure-welding portion, the terminal can be designed without constraints on the portion electromagnetically welded to the conductor, thus increasing the degree of design freedom of the terminal. Moreover, the first electromagnetically welding portion of the tubular intermediate component is electromagnetically welded to the conductor, and the second electromagnetically welding portion of the intermediate component is electromagnetically welded to the coupling portion of the terminal. As such, the first electromagnetically welding portion and the second electromagnetically welding portion can be pressure welded more uniformly in the circumferential direction in comparison to pressure welding using mechanical crimping, thus improving the conductivity between the conductor and the terminal via the intermediate component. Additionally, as the conductor of the electric wire and the intermediate component are made of the same type of metal, as opposed to being made of different types of metal, the pressure welding force of the electromagnetic welding of the first electromagnetically welding portion of the intermediate component to the conductor can be increased. In other words, a terminal-equipped electric wire can be provided in which the pressure welding force of the electromagnetically welding part on the conductor is increased.

It should be noted that the phrasing “the conductor and the intermediate component are made of the same type of metal” encompasses the case in which the conductor and the intermediate component are made of the same type of metal, the case in which they are made of a specific metal and an alloy containing that metal, such as aluminum or aluminum alloy, and the case in which they are made of alloys containing a specific metal.
(2) The conductor of the electric wire and the intermediate component are preferably made of aluminum or an aluminum alloy. As the conductor of the electric wire and the intermediate component are made of aluminum or an aluminum alloy, it is possible to reduce the weight of the terminal-equipped electric wire. Moreover, since the conductor and the intermediate component are made of the same type of aluminum-based metal, the rigidity of the electromagnetic welding of the first electromagnetically welding portion of the intermediate component to the conductor can be increased. Note that, as the coupling portion of the terminal is more rigid than the conductor of the electric wire formed by a plurality of bare strands, even if it is of a different metal, for example, copper or a copper alloy, from the intermediate component, its conductivity can be ensured by metallically bonding to the second electromagnetically welding portion of the intermediate component.
(3) Preferably, the conductor has a circular cross-sectional shape, the intermediate component has a cylindrical shape, and the coupling portion of the terminal has a cylindrical shape. According to this structure, as the diameters of the first and the second electromagnetically welding portions of the intermediate component are reduced circumferentially uniformly around the intermediate component under the electromagnetic force of electromagnetic welding, the first and the second electromagnetically welding portions are uniformly pressure welded to the circular cross-section the conductor and the cylindrical coupling portion in their respective circumferential directions. As such, the conductivity is further improved between the conductor and the intermediate component and the terminal.
(4) Preferably, the intermediate component includes a central large-diameter portion located between the first electromagnetically welding portion and the second electromagnetically welding portion in an axial direction of the intermediate component, the central large-diameter portion having a diameter larger than the first electromagnetically welding portion and the second electromagnetically welding portion. As the large-diameter central portion is provided at an axial center of the intermediate portion and has a larger diameter than the first electromagnetically welding portion and the second electromagnetically welding portion, the large-diameter central portion can be used to, for example, position the terminal-equipped electric wire. Moreover, as the first electromagnetically welding portion and the second electromagnetically welding portion of the intermediate portion are spaced apart from each other in the axial direction, separate discharge coils can be disposed around the first electromagnetically welding portion and the second electromagnetically welding portion, respectively, when performing electromagnetic welding. This allows for a greater degree of freedom in manufacturing, such as setting different conditions of electromagnetic welding for the first electromagnetic welding portion and the second electromagnetic welding portion.
(5) Preferably, the first electromagnetically welding portion and the second electromagnetically welding portion are connected in the axial direction of the intermediate component. As the first electromagnetically welding portion and the second electromagnetically welding portion of the coupling portion are connected in the axial direction, a single discharge coil can be disposed around the first electromagnetically welding portion and the second electromagnetically welding portion for simultaneous electromagnetic welding. As such, the number of steps and components for performing electromagnetic welding can be reduced so as to simplify the manufacturing process.
(6) A method of manufacturing a terminal-equipped electric wire of the present disclosure is a method of manufacturing a terminal-equipped electric wire that includes an electric wire in which a conductor composed of a plurality of bare strands is covered with an insulating coating, a tubular intermediate component, and a terminal, the method including the steps of: stripping off the insulating coating to expose the conductor at a terminal end of the electric wire; preparing the terminal, the terminal including, at one, a connecting portion for connection with a mating terminal and, at another end, a tubular coupling portion for coupling to the intermediate portion; preparing the intermediate component, the intermediate component being made of the same type of metal as the conductor of the electric wire; and electromagnetic welding by fitting one end of the intermediate component onto the conductor exposed at a terminal end of the electric wire for electromagnetic welding to provide a first electromagnetically welding portion on the one end of the intermediate component, and fitting another end of the intermediate component onto the coupling portion of the terminal for electromagnetic welding to provide a second electromagnetically welding portion on the other end of the intermediate component.

According to the manufacturing method, the terminal-equipped electric wire of the present disclosure can be advantageously manufactured to realize the same operations and effects of the terminal-equipped electric wire of the present disclosure.

### Details of Embodiments of Disclosure

Specific examples of a terminal-equipped electric wire and a method of manufacturing a terminal-equipped electric wire of the present disclosure will be described hereinafter with reference to the drawings. Note that the present disclosure is not limited to these examples, and is indicated by the claims, and is intended to include all modifications within the meaning and range of equivalency to the claims.

### Embodiment 1

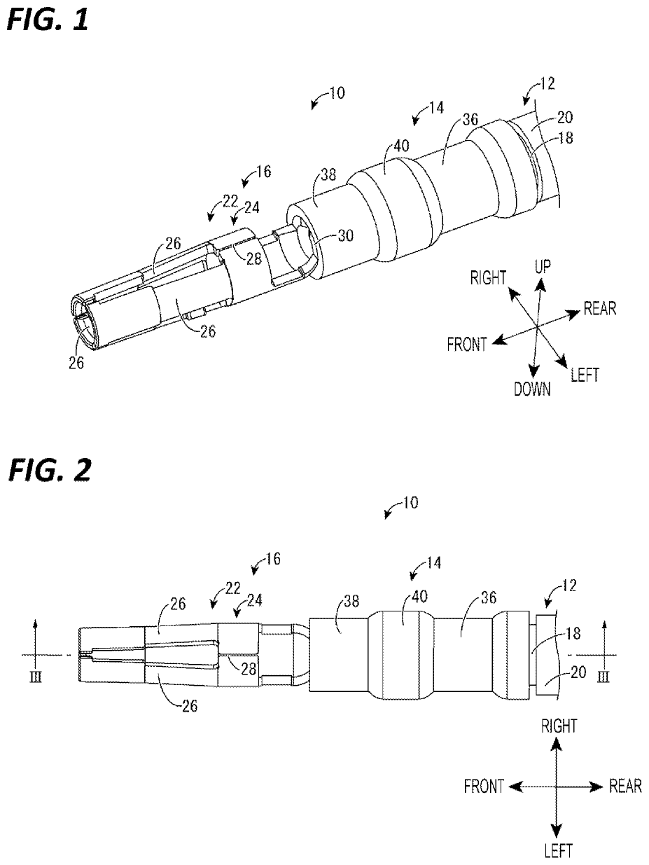

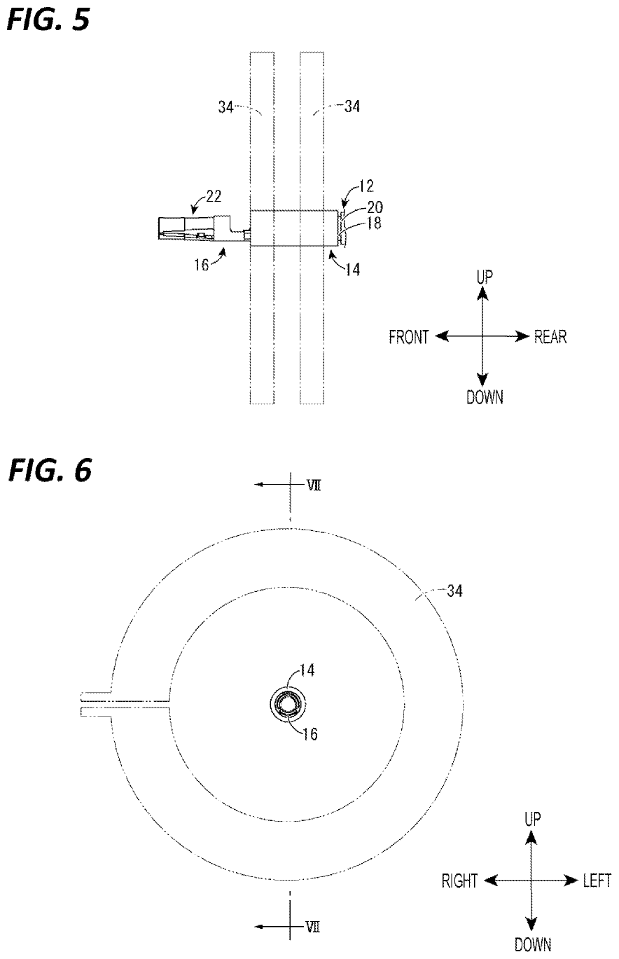

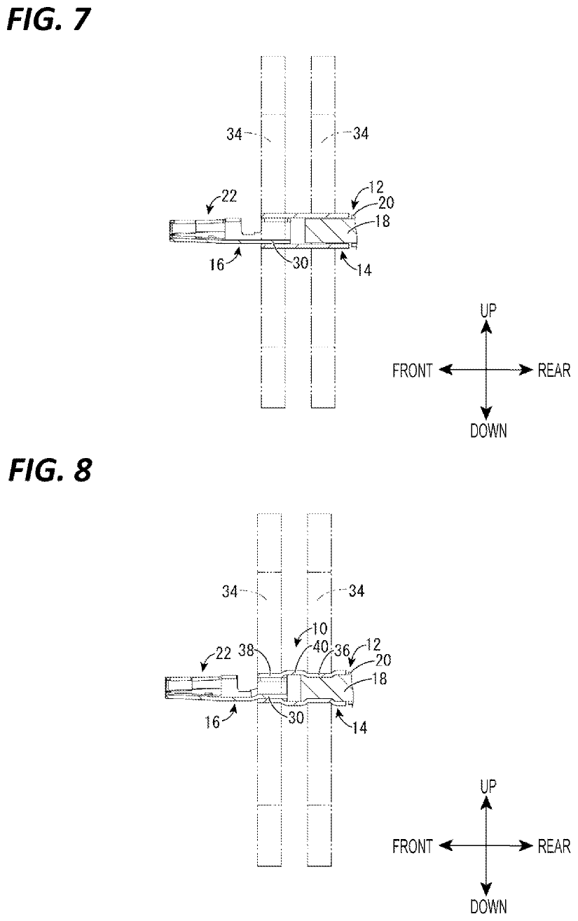

A terminal-equipped electric wire 10 of an Embodiment 1 of the present disclosure will be described hereinafter with reference to FIGS. 1 to 8. The terminal-equipped electric wire 10 includes a single electric wire 12, a tubular intermediate component 14, and a terminal 16. It should be noted that, although the terminal-equipped electric wire 10 can be disposed in any orientation, up-down, left-right, and front-rear directions are described below with reference to the up-down, left-right, and front-rear directions as shown in the drawings. Furthermore, where there is a plurality of identical members, some of the identical members may be indicated by a reference symbol while such indication may be omitted for the remaining members.

Electric Wire 12

The electric wire 12 is constructed by covering a conductor 18 comprised of a bundle of bare strands made of an aluminum-based material, such as aluminum or an aluminum alloy, with an insulating coating 20 having electrical insulation properties, such as ethylene-based resin or styrene-based resin. As shown in FIG. 4, the conductor 18 has a circular cross-sectional shape.

Intermediate Component 14

The intermediate component 14 is formed, for example, by cutting a metal pipe-shaped member to a predetermined length. As a result, the intermediate component 14 has a cylindrical shape that is open at two ends along the longitudinal direction thereof (the front-rear direction in FIG. 4). For example, aluminum and aluminum-based materials such as an aluminum alloy can be conceived as the metal material that constitutes the intermediate component 14. In other words, the intermediate component 14 and the conductor 18 of the electric wire 12 are made of the same type of metal. For example, the conductor 18 and the intermediate component 14 may be made of aluminum, or they may be made of either aluminum and an aluminum alloy or an aluminum alloy. Additionally, the inner diameter of the intermediate component 14 is slightly larger than the diameter of the conductor 18 of the electric wire 12 and the outer diameter of a coupling portion 30 of the terminal 16, which will be described below, so as to facilitate the insertion of the conductor 18 of the electric wire 12 and the coupling portion 30 of the terminal 16 into the intermediate component 14.

Terminal 16

The terminal 16 is made by pressing a flat metal plate into a predetermined shape. The flat metal plate can be made of a metal, such as copper, a copper alloy, etc. The terminal 16 includes a connecting portion 22 at one end thereof (the front end in FIG. 4) for connection with an unshown mating terminal. The connecting portion 22 is provided with a cylindrical tubular portion 24 at the proximal end thereof (the rear end in FIG. 4) and includes, at the distal end thereof (the front end in FIG. 4), three elastic contact segments 26 that have a flat rectangular plate shape and protrude forward from the tubular portion 24. Connection is established with the mating terminal by inserting the mating terminal between the three elastic contact segments 26. The tubular portion 24 is provided with a slit 28 extending longitudinally (in the front-rear direction in FIG. 4) over the entire length thereof, and thus the diameter of the tubular portion 24 can be increased to accommodate a large-diameter mating terminal. The cylindrical coupling portion 30 is provided at the other end (the rear end in FIG. 4) of the terminal 16. The coupling portion 30 is provided with a slit 32 extending longitudinally (in the front-rear direction in FIG. 4) along the entire length thereof, and thus the diameter of the coupling portion 30 can be reduced to facilitate insertion into the intermediate component 14. As described below, the coupling portion 30 is configured to be coupled to, and be electrically connected with, the intermediate component 14.

Method of Manufacturing Terminal-Equipped Electric Wire 10

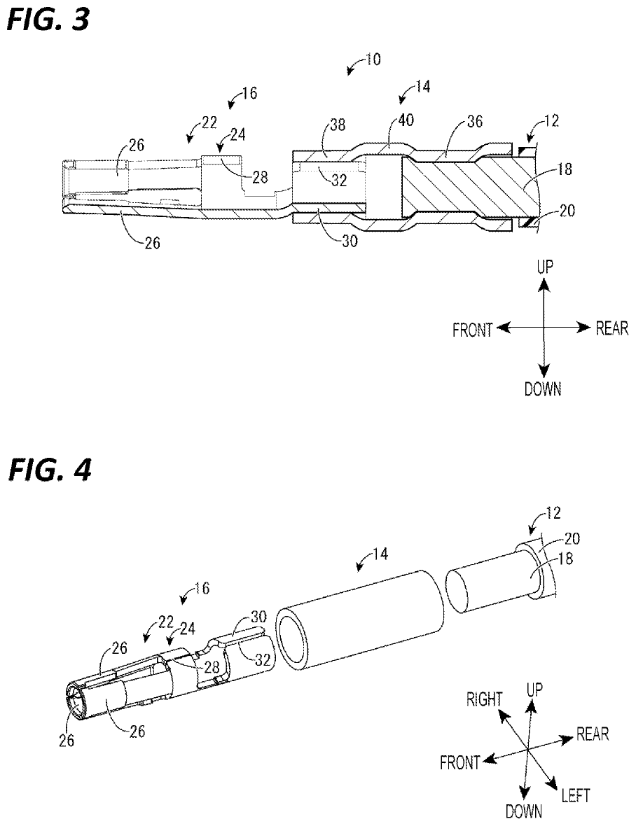

A method of manufacturing the terminal-equipped electric wire 10 will be described with reference to FIGS. 3 to 8. First, as shown in FIG. 4, an electric wire 12 is prepared, and the step of stripping off the insulating coating 20 is performed to expose the conductor 18 at a terminal end (the front end in FIG. 4) of the electric wire 12. Next, the step of preparing the terminal 16 is performed. Additionally, the step of preparing the intermediate component 14 is performed. Subsequently, as shown in FIGS. 4 to 7, one end (the rear end in FIG. 4) of the intermediate component 14 is fitted onto the conductor 18 exposed at the terminal end of the electric wire 12, and the other end (the front end in FIG. 4) of the intermediate component 14 is fitted onto the coupling portion 30 of the terminal 16. Then, two discharge coils 34 are arranged so that the exposed conductor 18 and the coupling portion 30 are located at their respective centers. Here, the discharge coils 34 are shown using imaginary lines to facilitate understanding. In FIG. 6, when a discharge current is passed through the discharge coils 34 (in the counterclockwise direction in FIG. 6), the discharge current generates magnetic fields between the outer discharge coils 34 and the intermediate component 14 (in the vertical direction with respect to the sheet of FIG. 6). At this time, an induced current is generated in the intermediate component 14 (in the clockwise direction in FIG. 6) in response to electromagnetic induction. Therefore, electromagnetic forces in the direction of radial reduction that are based on the magnetic fields and induced current act on the intermediate component 14. As a result, as shown in FIG. 8, one end of the intermediate component 14 is electromagnetically welded for electrical connection to the conductor 18 exposed at the terminal end of the electric wire 12 so as to provide a first electromagnetically welding portion 36 at the one end of the intermediate component 14. Moreover, the other end of the intermediate component 14 is electromagnetically welded for electrical connection to the coupling portion 30 of the terminal 16 so as to provide a second electromagnetically welding portion 38 at the other end of the intermediate component 14. The step of electromagnetic welding is performed as above.

In this way, the terminal-equipped electric wire 10 of the present embodiment is completed. In the terminal-equipped electric wire 10, as shown in FIGS. 3 and 8, the intermediate portion 14 includes a central large-diameter portion 40 whose diameter is larger than that of the first electromagnetically welding portion 36 and the second electromagnetically welding portion 38. The central large-diameter portion 40 is located between the first electromagnetically welding portion 36 and the second electromagnetically welding portion 38 in the axial direction (the front-rear direction) of the intermediate portion 14.

According to the terminal-equipped electric wire 10 of the present disclosure thus constructed, three separate components (the electric wire 12, the intermediate component 14, and the terminal 16) are interconnected through electromagnetic welding to provide the terminal-equipped electric wire 10. Therefore, the component connected to the conductor 18 exposed at a terminal end of the electric wire 12, i.e., the intermediate component 14, can be separated from the terminal 16. As a result, the degree of design freedom of the terminal 16 can be increased compared with a conventional structure that requires the fabrication of a terminal 16 having an integrated conductor crimp portion. Moreover, the first electromagnetically welding portion 36 of the intermediate component 14 is electromagnetically welded to the conductor 18 of the electric wire 12, and the second electromagnetically welding portion 38 of the intermediate component 14 is electromagnetically welded to the coupling portion 30 of the terminal 16. As such, the first electromagnetically welding portion 36 and the second electromagnetically welding portion 38 can be pressure welded more uniformly in the circumferential direction in comparison to pressure welding using mechanical crimping. Therefore, the conductivity can be improved between the conductor 18 and the terminal 16 via the intermediate component 14. Additionally, as the conductor 18 of the electric wire 12 and the intermediate component 14 are made of the same type of metal, as opposed to being made of different types of metal, it is possible to increase the pressure welding force of the electromagnetic welding of the first electromagnetically welding portion 36 of the intermediate component 14 to the conductor 18.

Moreover, as the diameters of the first electromagnetically welding portion 36 and the second electromagnetically welding portion 38 of the intermediate component 14 are reduced circumferentially uniformly around the intermediate component 14 using the electromagnetic force of electromagnetic welding, the first and second electromagnetically welding portions are uniformly pressure welded to the circular cross-section the conductor 18 and the cylindrical coupling portion 30 in their respective circumferential directions. As such, the conductivity can be further improved between the conductor 18 and the intermediate component 14 and the terminal 16.

Additionally, as the conductor 18 of the electric wire 12 and the intermediate component 14 are made of aluminum or an aluminum alloy, it is possible to reduce the weight of the terminal-equipped electric wire 10. Moreover, since the conductor 18 and the intermediate component 14 are made of the same type of aluminum-based metal, the pressure welding force of the first electromagnetically welding portion 36 of the intermediate component 14 on the conductor 18 can be increased. It should be noted that the coupling portion 30 of the terminal 16 is more rigid than the conductor 18 of the electric wire 12 made of a plurality of bare strands. Therefore, even if the conductor 16 is made of a different metal, for example, copper or a copper alloy, from the intermediate component 14, conductivity can be ensured upon electromagnetically welding the second electromagnetically welding portion 38 of the intermediate component 14 to the coupling portion 30 of the terminal 16.

Furthermore, provided at the axial center of the intermediate portion 14 is a large-diameter central portion 40 that has a larger diameter than the first electromagnetically welding portion 36 and the second electromagnetically welding portion 38. As a result, the central large-diameter portion 40 can be used, for example, for positioning the terminal-equipped wire 10. Moreover, the first electromagnetically welding portion 36 and the second electromagnetically welding portion 38 of the intermediate component 14 are axially spaced apart from each other. That is, when performing electromagnetic welding, separate discharge coils 34 can be disposed around the first electromagnetically welding portion 36 and the second electromagnetically welding portion 38. This allows for a greater degree of freedom in manufacturing, such as setting different conditions of electromagnetic welding for the first electromagnetic welding portion 36 and the second electromagnetic welding portion 38.

Variations

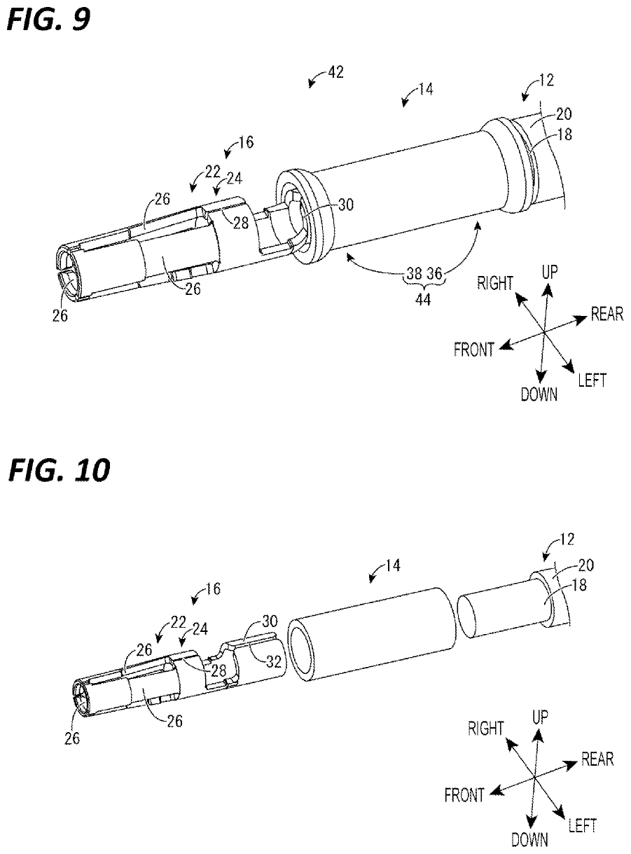

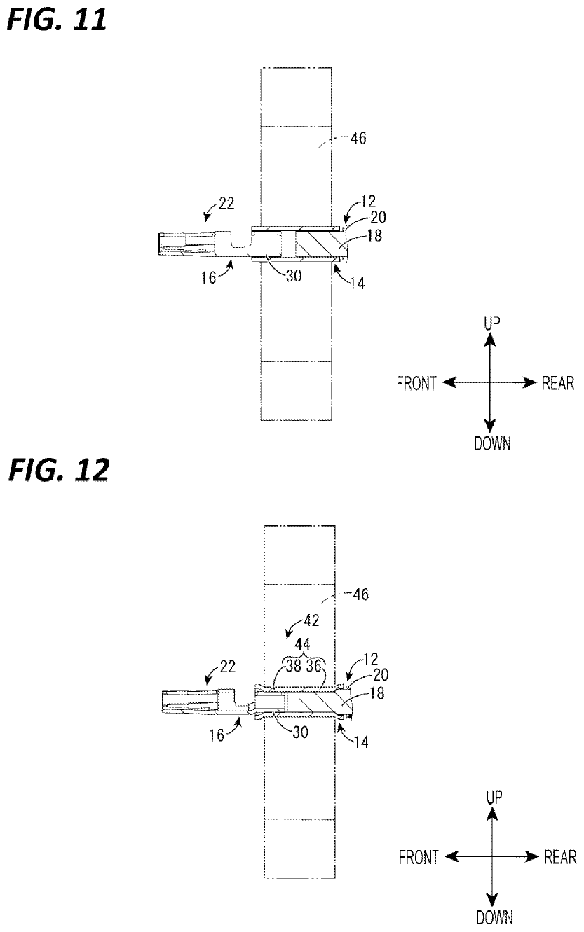

Having thus described Embodiment 1 in detail as a specific example of the present disclosure, the present disclosure is not limited to this specific description. Variations, improvements, etc. are included in the present disclosure to the extent that they can achieve the objects of the present disclosure. For example, the variations of the embodiment set forth below are included in the technical scope of the present disclosure.
(1) In the terminal-equipped electric wire 10 of Embodiment 1 above, the first electromagnetically welding portion 36 and the second electromagnetically welding portion 38 of the intermediate component 14 are axially spaced apart from each other, but the present invention is not limited to this. As in a terminal-equipped electric wire 42 shown in FIGS. 9 to 12, which is Embodiment 2 of the present disclosure, the first electromagnetically welding portion 36 and the second electromagnetically welding portion 38 may be connected to each other in the axial direction of the intermediate component 14. In other words, the first electromagnetically welding portion 36 and the second electromagnetically welding portion 38 may be formed by a single electromagnetically welding portion 44. As a result, as shown in FIGS. 11 and 12, a single discharge coil 46 may be disposed around the first electromagnetically welding portion 36 and the second electromagnetically welding portion 38, which constitute the electromagnetically welding portion 44, to enable concurrent electromagnetic welding. In this way, the number of steps and components for performing electromagnetic welding can be reduced so as to simplify the manufacturing process.
(2) In the terminal-equipped electric wire 10 of Embodiment 1 above, the intermediate component 14 has been described as a seamless tubular body without a circumferential cut, but it may be a tubular body with a circumferential cut or slit. Furthermore, although the coupling portion 30 of the terminal 16 has been described as a tubular portion with a slit 32, the slit 32 may be connected through welding or the like.
(3) In the terminal-equipped electric wire 10 of Embodiment 1 above, the intermediate component 14 and the coupling portion 30 of the terminal 16 have been described as having cylindrical shapes, but they may have elliptically cylindrical shapes. Moreover, the cross-sectional shape of the conductor 18 of the electric wire 12 is not limited to a circular cross-sectional shape; it may be an elliptic cylindrical shape. In other words, the electric wire 12 preferably has an outer peripheral shape that conforms to the inner peripheral shape of the intermediate component 14.

### LIST OF REFERENCE NUMERALS

10 Terminal-equipped electric wire (Embodiment 1)
12 Electric wire
14 Intermediate component
16 Terminal
18 Conductor
20 Insulating Coating
22 Connecting portion
24 Tubular portion
26 Elastic contact segment
28 Slit
30 Coupling portion
32 Slit
34 Discharge coil
36 First electromagnetically welding portion
38 Second electromagnetically welding portion
40 Central large-diameter portion
42 Terminal-equipped electric wire (Embodiment 2)
44 Electromagnetically welding portion
46 Discharge coil

1. A terminal-equipped electric wire comprising:
an electric wire in which a conductor composed of a plurality of bare strands is covered with an insulating coating, a tubular intermediate component, and a terminal;
wherein the terminal includes, at one end, a connecting portion for connection with a mating terminal and, at another end, a tubular coupling portion for coupling to the intermediate portion;
the intermediate component includes, at one end, a first electromagnetically welding portion that is fitted onto and electromagnetically welded to the conductor exposed at a terminal end of the electric wire and, at another end, a second electromagnetically welding portion that is fitted onto and electromagnetically welded to the coupling portion of the terminal, and
the conductor of the electric wire and the intermediate component are made of the same type of metal.

2. The terminal-equipped electric wire according to claim 1,
wherein the conductor of the electric wire and the intermediate component are made of aluminum or an aluminum alloy.

3. The terminal-equipped electric wire according to claim 1,
wherein the conductor has a circular cross-sectional shape, the intermediate component has a cylindrical shape, and the coupling portion of the terminal has a cylindrical shape.

4. The terminal-equipped electric wire according to claim 1,
wherein the intermediate component has a central large-diameter portion located between the first electromagnetically welding portion and the second electromagnetically welding portion in an axial direction of the intermediate component, the central large-diameter portion having a diameter larger than the first electromagnetically welding portion and the second electromagnetically welding portion.

5. The terminal-equipped electric wire according to claim 1,
wherein the first electromagnetically welding portion and the second electromagnetically welding portion are connected in the axial direction of the intermediate component.

6. A method of manufacturing a terminal-equipped electric wire including an electric wire in which a conductor composed of a plurality of bare strands is covered with an insulating coating, a tubular intermediate component, and a terminal, the method comprising the steps of:
stripping off the insulating coating to expose the conductor at a terminal end of the electric wire;
preparing the terminal, the terminal including, at one end, a connecting portion for connection with a mating terminal and, at another end, a tubular coupling portion for coupling to the intermediate portion;
preparing the intermediate component, the intermediate component being made of the same type of metal as the conductor of the electric wire; and
electromagnetic welding by fitting one end of the intermediate component onto the conductor exposed at a terminal end of the electric wire for electromagnetic welding to provide a first electromagnetically welding portion on the one end of the intermediate component, and fitting another end of the intermediate component onto the coupling portion of the terminal for electromagnetic welding to provide a second electromagnetically welding portion on the other end of the intermediate component.
